(19) United States
(12) Patent Application Publication
(10) Pub. No.: US 2019/0087060 A1
(43) Pub. Date: Mar. 21, 2019

(54) DYNAMIC ADJUSTMENT OF MEDIA THUMBNAIL IMAGE SIZE BASED ON TOUCHSCREEN PRESSURE

(71) Applicant: SLING MEDIA INC., Foster City, CA (US)

(72) Inventor: Andy OH, San Francisco, CA (US)

(73) Assignee: SLING MEDIA INC., Foster City, CA (US)

(21) Appl. No.: 15/708,928

(22) Filed: Sep. 19, 2017

(51) Int. Cl. G06F 3/0488; G06F 3/0485; G06F 3/0484; G06F 3/041

(52) U.S. Cl. CPC G06F 3/0488; G06F 3/04855; G06F 3/016; G06F 3/0414; G06F 3/04842; G06F 3/04845

(57) ABSTRACT

An electronic device includes a pressure-sensitive user interface component, a memory device, and a processor. The memory device has executable instructions that are executed by the processor to display a media player on a display of the electronic device. The media player includes a window for presentation of media content, a progress bar, and a play head indicating a playback position, wherein time scrolling of the media content is achieved by selection and movement of the play head along the progress bar. The method receives activation control information associated with selection of the play head, the control information including a force measurement of an amount of force imparted on the pressure-sensitive component, and the method renders a thumbnail image of the media content in response to receiving the control information, the thumbnail image having a displayed size that is influenced by the force measurement.

### TECHNICAL FIELD

Embodiments of the subject matter described herein relate generally to features and functions associated with client device applications, such as media player applications. More particularly, embodiments of the subject matter relate to the dynamic adjustment of media player scrollbar characteristics based on touchscreen pressure or force measurements.

### BACKGROUND

The prior art includes various media playback devices and media player applications designed to play audio and/or video content. Client devices (such as mobile phones, portable computer devices, desktop computer devices, gaming devices, and medical devices) typically include media player applications that can play streaming media content, locally stored or recorded media files, and/or media content stored on a tangible memory element such as flash memory, an optical disc, or the like. The presentation of video or audio content can also be supported by vehicle instrumentation panels, tools, system control panels, and the like.

Most conventional media player applications include a scrollable progress bar that allows the user to skip forward or backward to a specific program time, and that allows the user to scroll forward or backward through time by selecting, holding, and sliding a button or element on the progress bar (which is sometimes referred to as the play head). In certain applications, selecting or moving the play head along the progress bar results in the generation of small thumbnail images that provide a simple preview of the media content corresponding to the position of the play head on the progress bar.

Touchscreen displays are commonly used for mobile devices, tablet computer devices, laptop computer devices, desktop computer devices, vehicle instrument panels, medical equipment, remote control devices, navigation systems, and the like. Accordingly, conventional media player applications rendered on a touchscreen display can be controlled using finger touches, gestures, a stylus, or the like. Some touchscreen displays are pressure-sensitive in that the amount of force applied to the touchscreen surface is detected and used as additional user input information.

For various reasons, it is desirable to provide enhanced features in a media player application that is designed for deployment on a pressure-sensitive touchscreen display. A number of such enhanced features, along with other desirable functions and characteristics related to applications suitable for a device having a pressure-sensitive touchscreen display, will become apparent from the subsequent detailed description and the appended claims, taken in conjunction with the accompanying drawings and this background section.

### BRIEF SUMMARY

Disclosed herein is a method of controlling presentation of media content on a pressure-sensitive touchscreen display of an electronic device. An embodiment of the method involves displaying a media player on the pressure-sensitive touchscreen display, wherein the media player includes a primary window for presentation of media content, a progress bar, and a play head associated with the progress bar to indicate a playback position of the media content. Time scrolling of the media content is achieved by selection and movement of the play head along the progress bar. The method continues by receiving activation control information associated with user selection of the play head during presentation of the media content. The activation control information includes a force measurement corresponding to an amount of force imparted on or proximate to a displayed position of the play head on the pressure-sensitive touchscreen display. A thumbnail image of the media content is displayed in the media player in response to receiving the activation control information, wherein the thumbnail image has a displayed size that is influenced by the force measurement.

Also disclosed herein is an electronic device having: a pressure-sensitive user interface component; a memory storage device; and a processor device communicatively coupled to the memory storage device and to the pressure-sensitive user interface component, the memory storage device having computer executable instructions stored therein and configurable to be executed by the processor device to display a media player on a display of the electronic device, the media player having a primary window for presentation of media content, a progress bar, and a play head associated with the progress bar to indicate a playback position of the media content, wherein time scrolling of the media content is achieved by selection and movement of the play head along the progress bar. Activation activation control information associated with user selection of the play head during presentation of the media content is received, the activation control information including a force measurement corresponding to an amount of force imparted on the pressure-sensitive user interface component. A a thumbnail image of the media content is rendered in the media player in response to receiving the activation control information, the thumbnail image having a displayed size that is influenced by the force measurement.

Another method of controlling presentation of media content on a pressure-sensitive touchscreen display of an electronic device is also presented herein. An embodiment of this method displays a media player on the pressure-sensitive touchscreen display, the media player having a primary window for presentation of media content, a progress bar, and a play head associated with the progress bar to indicate a playback position of the media content, wherein time scrolling of the media content is achieved by selection and movement of the play head along the progress bar. The method continues by receiving activation control information associated with user selection of the play head during presentation of the media content, the activation control information including a force measurement corresponding to an amount of force imparted on or proximate to a displayed position of the play head on the pressure-sensitive touchscreen display. The method continues by controlling a variable granularity setting for time scrolling of the media content, in response to the force measurement.

Another embodiment of an electronic device is also presented here. The electronic device includes: a pressure-sensitive user interface component; a memory storage device; and a processor device communicatively coupled to the memory storage device and to the pressure-sensitive user interface component. The memory storage device has computer executable instructions stored therein and configurable to be executed by the processor device to perform a method that involves displaying a media player on a display of the electronic device, the media player having a primary window for presentation of media content, a progress bar, and a play head associated with the progress bar to indicate a playback position of the media content, wherein time scrolling of the media content is achieved by selection and movement of the play head along the progress bar. The method continues by receiving activation control information associated with user selection of the play head during presentation of the media content, the activation control information including a force measurement corresponding to an amount of force imparted on the pressure-sensitive user interface component. The method continues by controlling a variable granularity setting for time scrolling of the media content, in response to the force measurement.

Yet another method of controlling presentation of media content on a pressure-sensitive touchscreen display of an electronic device is also disclosed herein. An embodiment of this method displays a media player on the pressure-sensitive touchscreen display, the media player having a primary window for presentation of media content, a progress bar, and a play head associated with the progress bar to indicate a playback position of the media content, wherein time scrolling of the media content is achieved by selection and movement of the play head along the progress bar. The method continues by receiving activation control information associated with user selection of the play head during presentation of the media content, the activation control information including a force measurement corresponding to an amount of force imparted on or proximate to a displayed position of the play head on the pressure-sensitive touchscreen display. The method continues by controlling a variable user feedback setting for time scrolling of the media content, in response to the force measurement.

Yet another embodiment of an electronic device is disclosed herein. The electronic device includes: a pressure-sensitive user interface component; a memory storage device; and a processor device communicatively coupled to the memory storage device and to the pressure-sensitive user interface component. The memory storage device has computer executable instructions stored therein and configurable to be executed by the processor device to perform a method that displays a media player on a display of the electronic device, the media player having a primary window for presentation of media content, a progress bar, and a play head associated with the progress bar to indicate a playback position of the media content, wherein time scrolling of the media content is achieved by selection and movement of the play head along the progress bar. The method proceeds by receiving activation control information associated with user selection of the play head during presentation of the media content, the activation control information comprising a force measurement corresponding to an amount of force imparted on the pressure-sensitive user interface component. The method continues by controlling a variable user feedback setting for time scrolling of the media content, in response to the force measurement.

Also disclosed herein is a tangible and non-transitory computer readable storage medium having executable instructions stored thereon that, when executed by a processor device, are capable of performing any or all of the methods and processes summarized above.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram representation of an exemplary embodiment of a computer-based device having a pressure-sensitive touchscreen display;

FIG. 2 is a screen shot of an exemplary media player, as captured during presentation of video content;

FIG. 3 is a flow chart that illustrates an exemplary embodiment of a video presentation process;

FIG. 4 is a screen shot of the media player shown in FIG. 2, as captured during user selection and manipulation of the play head element;

FIG. 5 is another screen shot of the media player, as captured during user selection and manipulation of the play head element; and

FIGS. 6-8 depict a progress bar of an exemplary media player application in three different states corresponding to different granularity levels for time scrolling of media content.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software, firmware, or the like, various elements of the systems and devices described herein are essentially the code segments or instructions that cause one or more processor devices to perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

The subject matter presented here relates to certain features of a media player application that can be rendered on a pressure-sensitive (i.e., force-sensitive) touchscreen display. The amount of force imparted to the touchscreen display is utilized as an additional input signal for purposes of controlling one or more features or functions of the media player. The media player described herein can support the playback of audio content, video-only content, video content that includes audio (i.e., traditional video content), a slideshow of still images, or the like. For ease of description and simplicity, the following description refers to the presentation of video content in the context of an exemplary video player embodiment.

A media player of the type described herein can be rendered and displayed on any suitably configured pressure-sensitive touchscreen display. The touchscreen display can be integrated with a host electronic device, or it can be a distinct component that communicates and cooperates with an electronic device. In certain embodiments, a touchscreen display or any suitable pressure-sensitive or touch-sensitive element can be realized as a removable peripheral component that is compatible with a host electronic device. In yet other embodiments, the touchscreen display can be implemented with a more complex system, tool, or instrument (such as a vehicle, a piece of manufacturing equipment, an appliance, or the like). In this regard, an electronic device having a pressure-sensitive touchscreen display can be realized as any of the following devices, systems, or components, without limitation: a mobile telephone; a personal computer (in any form factor, including a desktop, a laptop, a handheld, etc.); a tablet computing device; a wearable computing device; a video game device or console; a digital media player device; a household appliance; a piece of home entertainment equipment; a medical device; a navigation device; an electronic toy or game; a vehicle instrument or instrument panel; a control panel of a piece of machinery, a tool, or the like; a digital camera or video camera; a weapon; a musical instrument; or a remote control device. It should be appreciated that this list is not exhaustive, and it is not intended to limit the scope or application of the embodiments described herein.

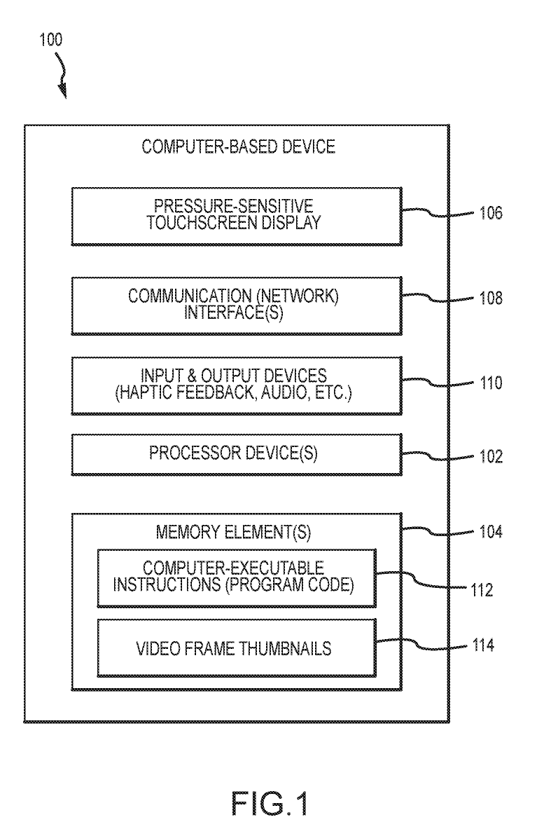

Turning now to the drawings, FIG. 1 is a simplified block diagram representation of an exemplary embodiment of a computer-based device 100 that supports the presentation of media content. The device 100 generally includes, without limitation: at least one processor device 102; at least one memory element 104; a pressure-sensitive touchscreen display 106; at least one communication (network) interface 108; and input and output (I/O) devices 110. In practice, the device 100 can include additional components, elements, and functionality that may be conventional in nature or unrelated to the particular media playback functionality described here. In this regard, the device 100 can include a pressure-sensitive trackpad with buttons, a peripheral touchpad, or the like, instead of or in addition to the touchscreen display 106. The following description refers to the touchscreen display 106 as being one practical and exemplary embodiment of a pressure-sensitive user interface component that can be utilized with the device 100.

A processor device 102 may be, for example, a central processing unit (CPU), a field programmable gate array (FPGA), a microcontroller, an application specific integrated circuit (ASIC), or any other logic device or combination thereof. The memory element 104 is communicatively coupled to the processor device 102, and it can be implemented with any combination of volatile and non-volatile memory. The memory element 104 has non-transitory computer-executable instructions (program code) 112 stored thereon, wherein the instructions 112 are configurable to be executed by the processor device 102 as needed. When executed by the processor device 102, the instructions 112 cause the processor device 102 to perform the associated tasks, processes, and operations defined by the instructions 112. Of course, the memory element 104 may also include instructions associated with a file system of the host device 100 and instructions associated with other applications or programs. Moreover, the memory element 104 can serve as a data storage unit for the host device 100. For example, the memory element 104 can provide a storage buffer for thumbnail images 114 (e.g., video frame thumbnails, selected screenshots, or the like) that are processed and displayed during media scrolling operations. In certain embodiments, the memory element 104 stores “full size” thumbnail images for the media content, and those thumbnail images are resizable as needed for display.

The pressure-sensitive touchscreen display 106 may be integrated with the device 100 or communicatively coupled to the device 100 as a peripheral or accessory component. The shape, size, resolution, and technology of the touchscreen display 106 will be appropriate to the particular implementation of the device 100. The touchscreen display 106 can be realized as a monitor, screen, or another conventional electronic display that is capable of graphically presenting data and/or information provided by the device 100. The touchscreen display 106 is communicatively coupled to the processor device 102, and it can leverage existing technology to detect touch gestures and contact with a user's finger (or fingers), a stylus, or the like. In addition, the touchscreen display 106 is suitably configured to generate or otherwise provide activation control information that is associated with touch and force detected at the surface of the touchscreen display 106. To this end, the activation control information includes or otherwise indicates a force measurement corresponding to an amount of force imparted on the touchscreen display 106. For example, if the user presses lightly on the surface of the touchscreen display 106, then the corresponding force measurement will be relatively low. In contrast, if the user presses hard on the surface of the touchscreen display 106, then the corresponding force measurement will be relatively high. The touchscreen display 106 is suitably configured to detect a desirable range of surface pressure imparted to its surface, and to generate a corresponding output, encoded data, an analog signal, or other information that is indicative of the amount of force/pressure imparted to the surface.

The communication interface 108 represents the hardware, software, and processing logic that enables the device 100 to support data communication with other devices. In practice, the communication interface 108 can be suitably configured to support wireless and/or wired data communication protocols as appropriate to the particular embodiment. For example, if the device 100 is a smartphone, then the communication interface 108 can be designed to support a cellular communication protocol, a short-range wireless protocol (such as the BLUETOOTH communication protocol), and a WLAN protocol. As another example, if the device 100 is a desktop or laptop computer, then the communication interface can be designed to support the BLUETOOTH communication protocol, a WLAN protocol, and a LAN communication protocol (e.g., Ethernet). In practice, the communication interface 108 enables the device 100 to receive media content for presentation on the touchscreen display 106, wherein the media content can be downloaded, streamed, or otherwise provided for real-time (or near real-time) playback or for storage at the device 100.

The I/O devices 110 enable the user of the device 100 to interact with the device 100 as needed. In practice, the I/O devices 110 may include, without limitation: a speaker, an audio transducer, or other audio feedback component; a haptic feedback device; a microphone; a mouse or other pointing device; a touchscreen or touchpad device; a keyboard; a joystick; or any conventional peripheral device. In this context, the touchscreen display 106 can be categorized as an I/O device 110. A haptic feedback device can be controlled to generate a variable amount of tactile or physical feedback, such as vibrations, a force, knock, or bump sensation, a detectable movement, or the like. Haptic feedback devices and related control schemes are well known and, therefore, will not be described in detail here.

This description assumes that an electronic device of the type described above can be operated to present media content to a user. The source, format, and resolution of the media content are unimportant for purposes of this description. Indeed, the data that conveys the media content can be locally stored at the electronic device, or it can be provided in a streaming media format from a content source, a service provider, a cloud-based entity, or the like. The following description assumes that the electronic device and the media player can successfully and compatibly process, render, and display the desired media (video) content in an appropriate manner.

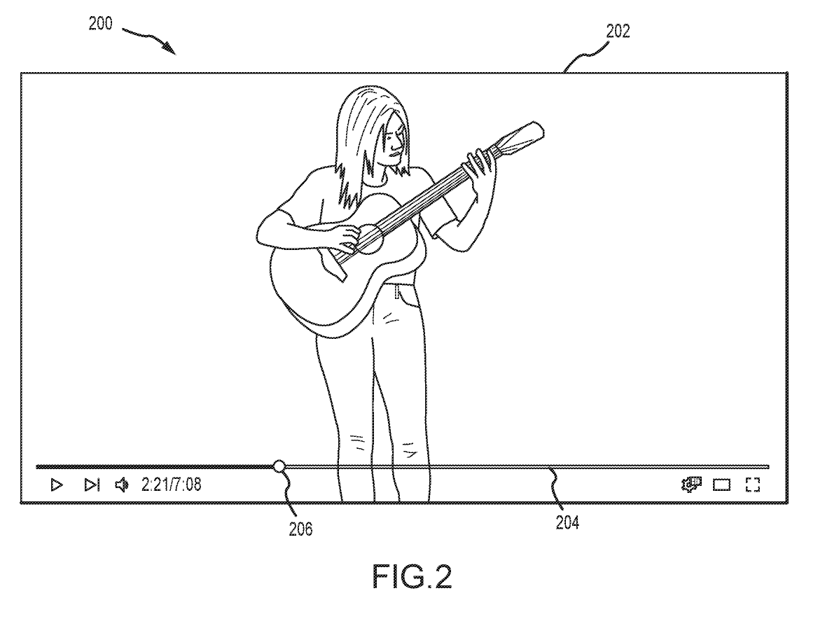

Although the media player can be designed and configured in a variety of different ways, certain basic features are found in the exemplary embodiments presented here. In this regard, FIG. 2 is a screen shot of an exemplary media player 200 captured during presentation of video content. The illustrated embodiment of the media player 200 includes a primary window 202 for the presentation of media content. The primary window 202 in FIG. 2 can be defined by the entire rectangular perimeter. FIG. 2 depicts a state wherein a progress bar 204, a play head 206, and other elements (such as: playback control icons, playback time information, window size control icons) are depicted. The play head 206 is rendered in association with the progress bar 204 and, in the illustrated embodiment, is rendered on or overlying the progress bar 204 to indicate the current playback position of the media content. The position of the play head 206 moves from the left to the right during playback of the media content, and the play head 206 becomes stationary or disappears when playback is paused or stopped.

The user can select a position along the progress bar 204 (by touching the display at that particular position) to skip forward or backward in the playback timeline of the media content. Selecting a position along the progress bar 204 also changes the location of the play head 206. In accordance with the exemplary embodiment described here, the play head 206 is an active element in that it can be touched, held, and dragged along the progress bar 204 to scroll through the media content during playback. Thus, time scrolling of the media content is achieved by selection and movement of the play head 206 along the progress bar 204. In practice, the user can simply press and hold the play head 206 to select it, and then slide the play head 206 to the left (to scroll back) or to the right (to scroll ahead) while maintaining pressure on the touchscreen display to ensure that the play head 206 remains selected.

User selection of the play head 206 during presentation of video content results in the generation and processing of associated activation control information. In other words, the host device is suitably configured to receive and respond to control data or sensor signals generated in response to user interaction and manipulation of the play head 206. For this example, the activation control information includes a force measurement corresponding to an amount of force or pressure imparted on or proximate to the displayed position of the play head 206 on the pressure-sensitive touchscreen display.

In accordance with certain embodiments, the media player 200 and/or the host device dynamically responds to the amount of force that is imparted to the play head 206 during a scrolling operation. This description contemplates at least three force-dependent or force-influenced characteristics that can be dynamically adjusted during media scrolling: variable thumbnail image size; variable scrolling granularity; and variable user feedback. Any of these force-dependent features (individually or in any desired combination) can be implemented by the media player 200 and/or by the host electronic device. In certain embodiments, the user can configure preferences for the media player 200 and/or the host electronic device to individually enable/disable the force-dependent features.

The media player 200 supports variable thumbnail images sizes, wherein thumbnail images of the primary video content are dynamically resized in a manner that is influenced by the force measurement corresponding to the force imparted to the play head 206. Depending on the particular embodiment and/or user preferences, the displayed size of a thumbnail image can be proportional to the force measurement (i.e., higher force/pressure results in larger thumbnail images) or inversely proportional to the force measurement (i.e., higher force/pressure results in smaller thumbnail images). In certain preferred embodiments, the displayed size of a thumbnail image is dynamically controlled to be proportional to the force measurement, by default.

The media player 200 also utilizes a variable granularity setting for time scrolling of the media content, wherein the scrolling granularity is dynamically adjusted in response to the force measurement (which in turn corresponds to the force imparted to the play head 206). In the context of this description, higher granularity settings for time scrolling of the media content correspond to a higher number of video frames displayed as thumbnails during scrolling. Conversely, lower granularity settings for time scrolling of the media content correspond to a lower number of video frames displayed as thumbnails during scrolling. In other words, higher granularity settings result in finer and more precise scrolling action, which makes it easier for the viewer to slowly scan video content if desired to find a specific scene, a particular image, or the like. Lower granularity settings result in coarser and less precise scrolling, which enables the view to quickly move through video content in larger “time steps” if so desired.

Depending on the particular embodiment and/or user preferences, the variable granularity setting for media scrolling can be proportional to the force measurement (i.e., higher force/pressure results in higher scrolling granularity) or inversely proportional to the force measurement (i.e., higher force/pressure results in lower scrolling granularity). In certain preferred embodiments, the scrolling granularity is dynamically controlled to be proportional to the force measurement, by default. In other words, by default, higher force/pressure on the play head results in finer scrolling resolution that displays more thumbnail images per unit of normal playback time, and vice versa.

The media player 200 also utilizes a variable user feedback setting for time scrolling of the media content, wherein certain characteristics of the feedback generated by the media player 200 and/or the host electronic device are dynamically adjusted in response to the force measurement (which in turn corresponds to the force imparted to the play head 206). In accordance with certain embodiments, the variable user feedback setting regulates characteristics of haptic feedback and/or audio feedback generated in association with time scrolling of the media content.

Depending on the particular embodiment and/or user preferences, the variable user feedback setting can be controlled such that the amount of haptic feedback and/or certain tactilely detectable characteristics of the haptic feedback generated in association with time scrolling of the media content is proportional to the force measurement (e.g., higher force/pressure results in more haptic feedback) or inversely proportional to the force measurement (e.g., higher force/pressure results in less haptic feedback). The controllable characteristics of haptic feedback as regulated by the variable user feedback setting can include at least one of the following, without limitation: magnitude of the haptic feedback; the type or pattern of haptic feedback generated; and the frequency of the haptic feedback signal or pattern. In certain preferred embodiments, the amount of haptic feedback is dynamically controlled to be inversely proportional to the force measurement, by default.

Depending on the particular embodiment and/or user preferences, the variable user feedback setting can be controlled such that certain characteristics of audio feedback generated in association with time scrolling of the media content are proportional to the force measurement (e.g., higher force/pressure results in higher volume or higher frequency) or inversely proportional to the force measurement (e.g., higher force/pressure results in lower volume or lower frequency). The controllable characteristics of audio feedback as regulated by the variable user feedback setting can include at least one of the following, without limitation: volume; pitch; frequency; sound pattern; note pattern; timbre; and sound “type” or audio content (such as voice or speech, tones, musical instrument sounds, songs, or the like).

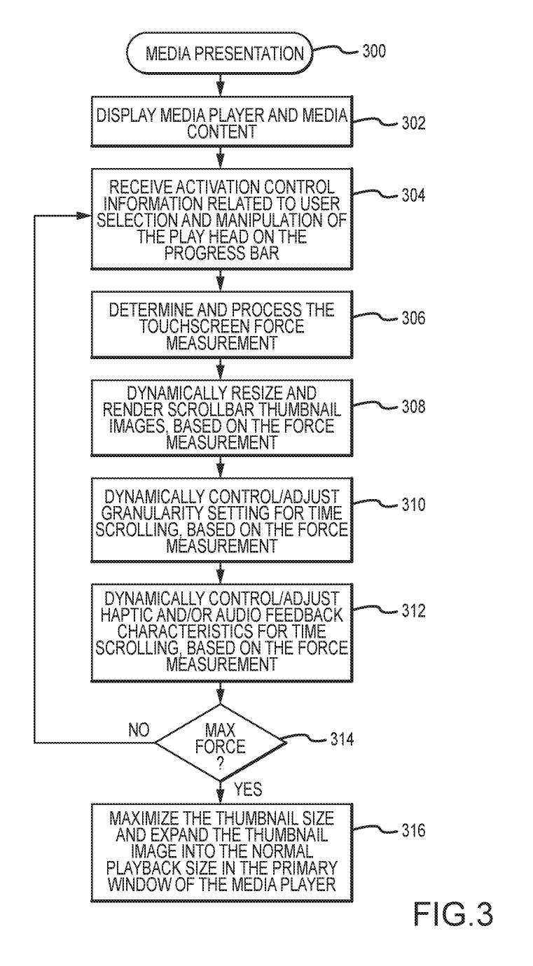

FIG. 3 is a flow chart that illustrates an exemplary embodiment of a media presentation process 300. The process 300 represents an embodiment of a method of controlling the presentation of video content on a pressure-sensitive touchscreen display of an electronic device. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., the touchscreen display 106, the processor device 102, or an I/O device 110. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 begins by displaying a media player and related media content on a pressure-sensitive touchscreen display of an electronic device, system, or instrument (task 302). This example assumes that the user has selected the play head 206 or has touched the progress bar 204 in a way that results in the selection of the play head 206 at the touched position. Accordingly, the process 300 receives the corresponding activation control information that is associated with user selection of the play head 206 (task 304). The activation control information is processed or analyzed in an appropriate manner to determine the current value of the touchscreen force measurement (task 306). The force measurement is then processed (as applicable) to adjust one or more of the force-dependent characteristics described above. In this regard, the process 300 controls the media player to dynamically resize and render scrollbar thumbnail images of the media content, based on the determined force measurement (task 308). Alternatively or additionally, the process 300 controls the media player to dynamically regulate, adjust, or control the variable granularity setting for time scrolling, based on the determined force measurement (task 310). Alternatively or additionally, the process 300 controls the media player to dynamically regulate, adjust, or control the variable user feedback granularity setting for time scrolling, based on the determined force measurement (task 312). In certain preferred embodiments, all of these force-influenced parameters are dynamically adjusted in response to the current force measurement. Accordingly, the process 300 continues by rendering a thumbnail image of the media content in the video player, wherein the thumbnail image has a displayed size that is influenced by the force measurement. In addition, the process 300 sets the variable scrolling granularity to a level that is influenced by the force measurement. Moreover, the process sets the variable user feedback setting or settings such that user feedback is generated with characteristics that are influenced by the force measurement. For the exemplary embodiment presented here, the displayed thumbnail image size is proportional to the amount of force applied to the play head 206, the scrolling granularity is inversely proportional to the amount of force applied to the play head 206, the amount or “detectability” of haptic feedback is inversely proportional to the amount of force applied to the play head 206, and at least one audio feedback characteristic varies in accordance with the amount of force applied to the play head 206.

The overall scheme described above continues in an ongoing manner such that one or more of the force-dependent features can be adjusted on the fly during a scrolling operation. The exemplary embodiment of the process 300 also checks whether the received force measurement exceeds a threshold or maximum value (query task 314). If not, then the process 300 continues as described previously (FIG. 3 shows the “No” branch of query task 314 leading back to task 304 to indicate the ongoing nature of the process 300). If the process 300 determines that the force measurement exceeds the threshold value (the “Yes” branch of query task 314), then the displayed size of the scrollbar thumbnail image is increased and maximized within the media player (task 316). After the thumbnail image size has been maximized, the process 300 continues by expanding the thumbnail image into a normal playback size of the primary window 202. In other words, the state of the media player transitions such that the thumbnail image grows to eventually fit the normal playback size in the primary window 202. This action can be performed automatically in response to the detection of force/pressure on the play head 206 that exceeds the maximum amount.

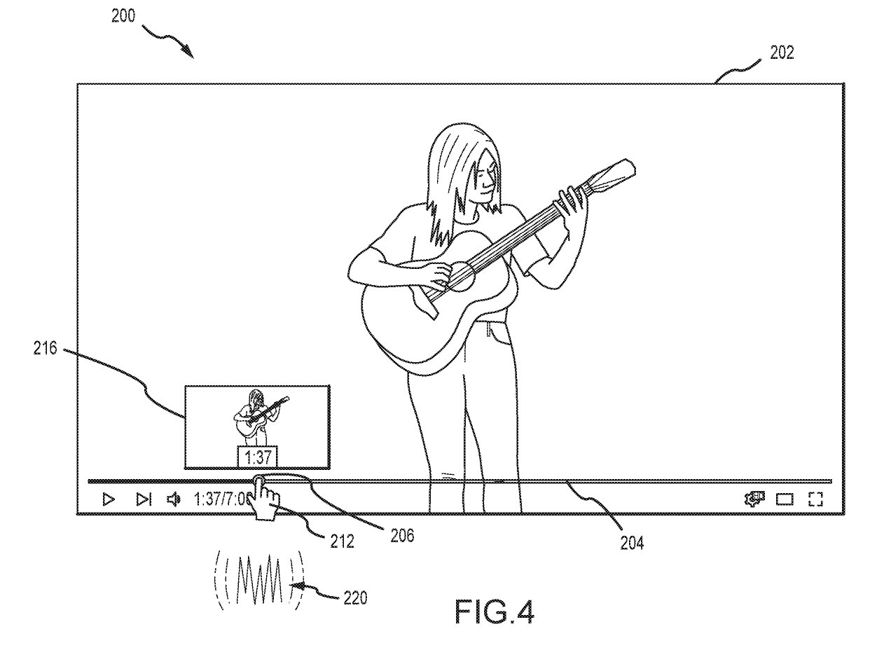

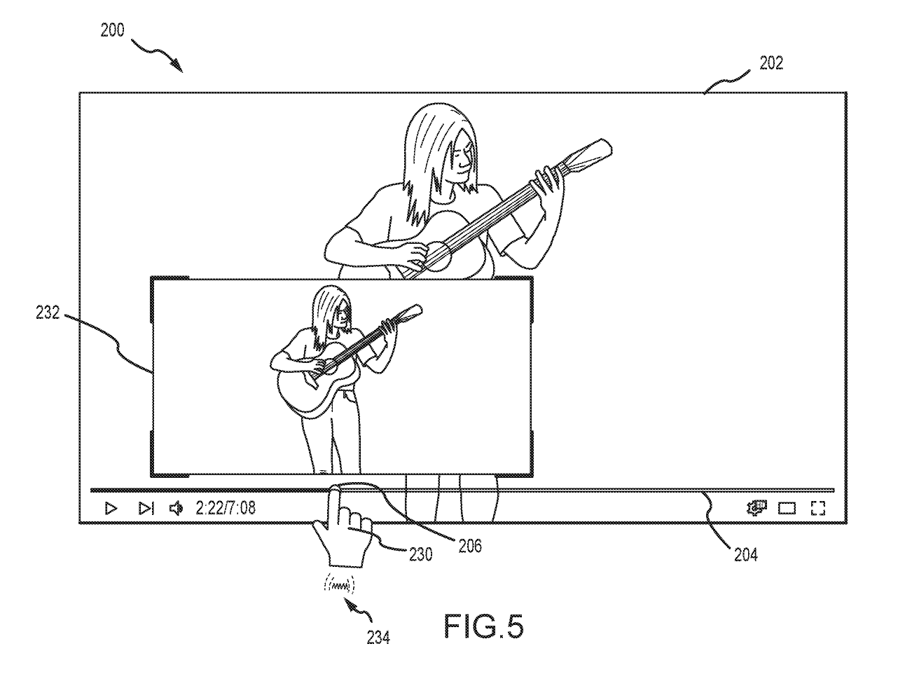

FIG. 4 and FIG. 5 visually demonstrate the force-dependent characteristics of the media player 200. More specifically, FIG. 4 is a screen shot of the media player 200, as captured during user selection and manipulation of the play head 206. FIG. 4 depicts a relatively small sized hand icon 212 to indicate that a relatively light force/pressure is being imparted to the pressure-sensitive touchscreen display at or near the rendered position of the play head 206. It should be appreciated that the hand icon 212 need not actually be displayed (and typically will not appear in a touchscreen implementation). The hand icon 212 is shown in FIG. 4 for ease of description and to demonstrate that the illustrated state of the media player 200 corresponds to the application of light force on the play head 206. In response to the use of light force on the play head 206, a relatively small sized thumbnail image 216 is rendered and displayed in the media player 200. In a typical implementation, the thumbnail image 216 is displayed at or near the location of the play head 206, as shown. FIG. 4 also schematically depicts a relatively noticeable amount of haptic and/or audio feedback 220 generated in association with scrolling movement of the play head 206. If the same amount of force (within a practical tolerance range) is applied to the play head 206 as it is moved along the progress bar 204, then the size of the thumbnail image 216 and the amount of haptic and/or audio feedback 220 will be maintained during the scrolling operation.

FIG. 5 is another screen shot of the media player 200, as captured during user selection and manipulation of the play head 206. FIG. 5 depicts a relatively large sized hand icon 230 to indicate that a relatively heavy force/pressure is being imparted to the pressure-sensitive touchscreen display at or near the rendered position of the play head 206. As mentioned above, the hand icon 230 is shown in FIG. 5 for demonstration purposes (it typically will not appear in a touchscreen implementation). In response to the use of heavy force on the play head 206, a relatively large sized thumbnail image 232 is rendered and displayed in the media player 200. In a typical implementation, the thumbnail image 232 is displayed in alignment with, or near, the location of the play head 206, as shown. FIG. 5 also schematically depicts a relatively low or less noticeable amount of haptic and/or audio feedback 234 generated in association with scrolling movement of the play head 206. If the same amount of force (within a practical tolerance range) is applied to the play head 206 as it is moved along the progress bar 204, then the size of the thumbnail image 232 and the amount of haptic and/or audio feedback 234 will be maintained during the scrolling operation. If the amount of force applied to the play head 206 decreases during the scrolling operation, then the thumbnail image size will shrink and the amount of haptic and/or audio feedback will change accordingly. If the amount of force applied to the play head 206 increases during the scrolling operation, then the thumbnail image size will expand and the amount of haptic and/or audio feedback will also change accordingly. As mentioned above, the thumbnail image size can expand to fit the normal playback screen size if the amount of force applied to the play head 206 exceeds a designated maximum value.

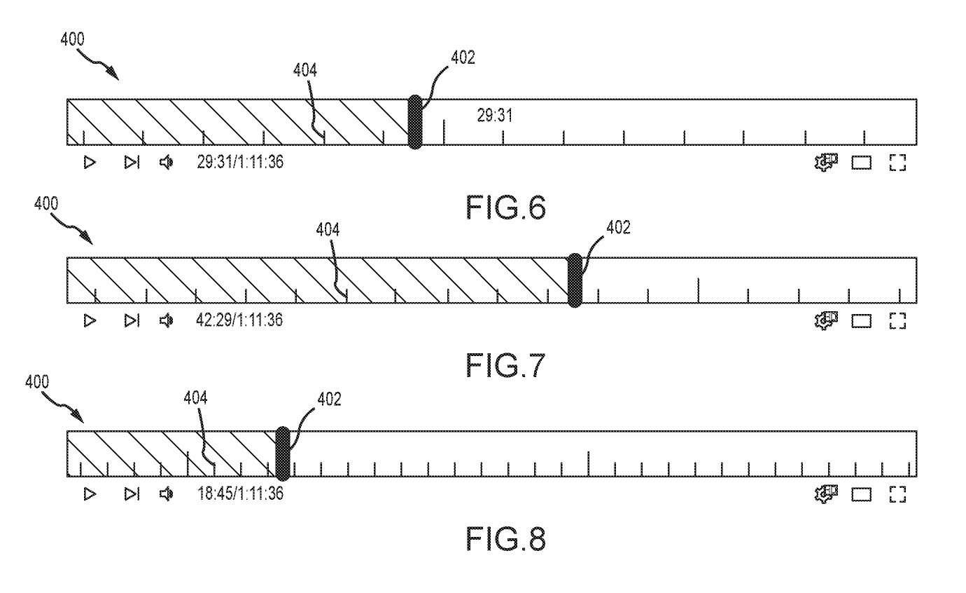

For ease of illustration and clarity, the variable scrollbar granularity feature is not shown in FIG. 4 or FIG. 5. Instead, this feature is depicted independently in FIGS. 6-8. To this end, FIGS. 6-8 depict a progress bar 400 of an exemplary video player application in three different states corresponding to different granularity levels for time scrolling of video content. FIG. 6 depicts the progress bar 400 in a state corresponding to the use of relatively low force/pressure on the displayed play head 402, FIG. 7 depicts the progress bar 400 in a state corresponding to the use of relatively intermediate force/pressure on the displayed play head 402, and FIG. 8 depicts the progress bar 400 in a state corresponding to the use of relatively high force/pressure on the displayed play head 402.

The vertical markers 404 rendered on or near the progress bar 400 provide a visual indication of the scrollbar granularity. For the illustrated embodiment, the spacing or pitch of the vertical markers 404 varies in accordance with the dynamically variable scrollbar granularity. Consequently, in FIG. 6, relatively wide spacing is used for the vertical markers 404 to indicate that a relatively low scrollbar granularity is currently active (due to the application of light force on the play head 402), which results in larger time “jumps” during the scrolling operation. In contrast, relatively narrow spacing is used for the vertical markers in FIG. 8 to indicate that a relatively high scrollbar granularity is currently active (due to the application of heavy force on the play head 402), which results in smaller time “jumps” during the scrolling operation. Similarly, the application of an intermediate force on the play head 402 results in a relatively intermediate scrollbar granularity and medium spacing of the vertical markers 404, as depicted in FIG. 7.

It should be appreciated that all of the force-dependent features need not be directly linked to or correlated with the force measurement. For example, the thumbnail image size might be directly influenced by the force measurement, and the variable scrolling granularity setting and/or the variable user feedback setting might be adjusted based on the controlled thumbnail image size (rather than directly based on the force measurement). In accordance with one specific example, the variable scrolling granularity behavior depicted in FIGS. 6-8 can be implemented in any media player that generates different sized scrollbar thumbnail images.

Furthermore, some or all of the force-dependent features described herein can also be used in other graphical user interface applications (if displayed on a pressure-sensitive touchscreen). For example, the force-dependent features can be utilized with other applications that use scrollbars, sliders, dropdown menus, or the like.

Although the techniques and methodologies described here are intended for use primarily with mobile devices having pressure-sensitive touchscreen displays, the disclosed concepts can also be ported for use with traditional computing devices that do not have touchscreens. For example, in a desktop computer system having a mouse or other non-touch pointing device, the displayed size of scrollbar thumbnail images can be adjusted based on a mouse clicking pattern, a click-and-hold time period, or the like. As another example, a mouse or other pointing device can be manipulated (using the left button, right button, other button(s), or scroll wheel) to select a desired thumbnail image size, which may also be linked to the variable granularity setting or the variable user feedback setting. As yet another example, the force-dependent features described here can be implemented in the context of a touchpad or trackpad device that is integrated with, or cooperates with, an electronic device and a non-touch display element. In this regard, a traditional desktop computer with a non-touch display monitor can be controlled using a touchpad peripheral rather than a mouse or trackball device. These and other applications and embodiments are contemplated by this disclosure.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of controlling presentation of media content on a pressure-sensitive touchscreen display of an electronic device, the method comprising:
displaying a media player on the pressure-sensitive touchscreen display, the media player comprising a primary window for presentation of media content, a progress bar, and a play head associated with the progress bar to indicate a playback position of the media content, wherein time scrolling of the media content is achieved by selection and movement of the play head along the progress bar;
receiving activation control information associated with user selection of the play head during presentation of the media content, the activation control information comprising a force measurement corresponding to an amount of force imparted on or proximate to a displayed position of the play head on the pressure-sensitive touchscreen display; and
rendering a thumbnail image of the media content in the media player in response to receiving the activation control information, the thumbnail image having a displayed size that is influenced by the force measurement.

2. The method of claim 1, wherein the displayed size of the thumbnail image is proportional to the force measurement.

3. The method of claim 1, further comprising:
determining that the force measurement exceeds a threshold value;
in response to the determining, maximizing the displayed size of the thumbnail image; and
after maximizing the displayed size of the thumbnail image, expanding the thumbnail image into a normal playback size of the primary window.

4. The method of claim 1, further comprising:
controlling a variable granularity setting for time scrolling of the media content, in response to the force measurement.

5. The method of claim 4, wherein:
higher granularity settings for time scrolling of the media content correspond to a higher number of video frames displayed during scrolling;
lower granularity settings for time scrolling of the media content correspond to a lower number of video frames displayed during scrolling; and
the controlling step controls the variable granularity setting to be proportional to the force measurement.

6. The method of claim 1, further comprising:
controlling a variable user feedback setting for time scrolling of the media content, in response to the force measurement.

7. The method of claim 6, wherein the variable user feedback setting regulates characteristics of haptic feedback generated in association with time scrolling of the media content.

8. The method of claim 6, wherein the variable user feedback setting regulates characteristics of audio feedback generated in association with time scrolling of the media content.

9. The method of claim 1, further comprising:
controlling a variable granularity setting for time scrolling of the media content, in response to the force measurement; and
controlling a variable user feedback setting for time scrolling of the media content, in response to the force measurement.

10. An electronic device comprising:
a pressure-sensitive user interface component;
a memory storage device; and
a processor device communicatively coupled to the memory storage device and to the pressure-sensitive user interface component, the memory storage device having computer executable instructions stored therein and configurable to be executed by the processor device to perform a method comprising:
displaying a media player on a display of the electronic device, the media player comprising a primary window for presentation of media content, a progress bar, and a play head associated with the progress bar to indicate a playback position of the media content, wherein time scrolling of the media content is achieved by selection and movement of the play head along the progress bar;
receiving activation control information associated with user selection of the play head during presentation of the media content, the activation control information comprising a force measurement corresponding to an amount of force imparted on the pressure-sensitive user interface component; and
rendering a thumbnail image of the media content in the media player in response to receiving the activation control information, the thumbnail image having a displayed size that is influenced by the force measurement.

11. The electronic device of claim 10, wherein the displayed size of the thumbnail image is proportional to the force measurement.

12. The electronic device of claim 10, wherein the method performed by the processor device further comprises:
determining that the force measurement exceeds a threshold value;
in response to the determining, maximizing the displayed size of the thumbnail image; and
after maximizing the displayed size of the thumbnail image, expanding the thumbnail image into a normal playback size of the primary window.

13. The electronic device of claim 10, wherein the method performed by the processor device further comprises:
controlling a variable granularity setting for time scrolling of the media content, in response to the force measurement.

14. The electronic device of claim 13, wherein:
higher granularity settings for time scrolling of the media content correspond to a higher number of video frames displayed during scrolling;
lower granularity settings for time scrolling of the media content correspond to a lower number of video frames displayed during scrolling; and
the controlling step controls the variable granularity setting to be proportional to the force measurement.

15. The electronic device of claim 10, wherein the method performed by the processor device further comprises:
controlling a variable user feedback setting for time scrolling of the media content, in response to the force measurement.

16. The electronic device of claim 15, wherein the variable user feedback setting regulates characteristics of haptic feedback generated in association with time scrolling of the media content.

17. The electronic device of claim 15, wherein the variable user feedback setting regulates characteristics of audio feedback generated in association with time scrolling of the media content.

18. The electronic device of claim 10, wherein pressure-sensitive user interface component comprises a touchscreen display.

19. A tangible and non-transitory computer readable storage medium having executable instructions stored thereon that, when executed by a processor device, are capable of performing a method of controlling presentation of media content on a pressure-sensitive touchscreen display of an electronic device, the method comprising:
displaying a media player on the pressure-sensitive touchscreen display, the media player comprising a primary window for presentation of media content, a progress bar, and a play head associated with the progress bar to indicate a playback position of the media content, wherein time scrolling of the media content is achieved by selection and movement of the play head along the progress bar;
receiving activation control information associated with user selection of the play head during presentation of the media content, the activation control information comprising a force measurement corresponding to an amount of force imparted on or proximate to a displayed position of the play head on the pressure-sensitive touchscreen display; and
rendering a thumbnail image of the media content in the media player in response to receiving the activation control information, the thumbnail image having a displayed size that is influenced by the force measurement.

20. The storage medium of claim 19, wherein the method further comprises:
controlling a variable granularity setting for time scrolling of the media content, in response to the force measurement; and
controlling a variable user feedback setting for time scrolling of the media content, in response to the force measurement.
